(19) United States
(12) Patent Application Publication
(10) Pub. No.: US 2016/0061106 A1
(43) Pub. Date: Mar. 3, 2016

(54) CRANKSHAFT FOR AN INTERNAL COMBUSTION ENGINE

(71) Applicant: EcoMotors, Inc., Allen Park, MI (US)

(72) Inventors: Vinita Verma, Dearborn, MI (US); Iain Ridley, Ann Arbor, MI (US); Peter Hofbauer, West Bloomfield, MI (US); Adrian Tusinean, Windsor (CA)

(21) Appl. No.: 14/829,949

(22) Filed: Aug. 19, 2015

Related U.S. Application Data
(60) Provisional application No. 62/041,825, filed on Aug. 26, 2014.
(60) Provisional application No. 62/060,887, filed on Oct. 7, 2014.

(51) Int. Cl. F02B 75/28; F16C 9/04; F16C 3/14; F16C 3/10; F01M 11/02; F02B 75/24

(52) U.S. Cl. CPC F02B 75/282; F01M 11/02; F02B 75/246; F16C 3/14; F16C 3/10; F16C 9/04; F01M 2011/026

(57) ABSTRACT

An internal combustion engine includes a crankshaft having a first web portion defining an inner opening and defining an undercut proximate the inner opening, a second web portion defining an inner opening and defining an undercut proximate the inner opening and an inner bearing portion that engages with the inner opening of the first web portion and with the inner opening of the second web portion. First and second pushrods each have a piston end and a crankshaft end. The crankshaft ends of the first and second pushrods each have a concave surface placed over different portions of the inner bearing portion between the first and second web portions, and each further have shoulders adjacent their respective concave surface that engage with the undercuts of the first and second web portions.

### CROSS-REFERENCE TO RELATED APPLICATION

This patent application claims the benefit of, and priority to, U.S. Provisional Patent Application Ser. No. 62/041,825, filed Aug. 26, 2014, and to U.S. Provisional Patent Application Ser. No. 62/060,887, filed Oct. 7, 2014, the disclosures of which are expressly incorporated herein by reference.

### FIELD OF THE INVENTION

The present invention relates generally to crankshafts for internal combustion engines, and more specifically to such crankshafts for opposed piston engines and/or opposed piston, opposed cylinder engines.

### BACKGROUND

Examples of conventional built-up crankshafts for internal combustion engines are shown in U.S. Pat. No. 7,469,664 and in U.S. Pat. No. 1,286,852. Such built-up crankshafts may implement fork-and-blade connecting rods, such as shown in FIG. 16 of U.S. Pat. No. 7,469,664. Such an arrangement allows two connecting rods to couple to a single journal, with the forked connecting rod and the blade connecting rod each wrapped around the entire circumference of the journal.

U.S. Patent Pub. No 2012/0207415 A1 and U.S. Patent Pub. No. 2012/0247419 A1 both disclose OPOC engines in which some of the connecting rods, e.g., so-called pushrods, are primarily in compression and others of the connecting rods, e.g., so-called pullrods, are primarily in tension, either of which means that the forces that such connecting rods impose on the journals of a crankshaft are primarily in unidirectional. Both publications disclose a unitary crankshaft and two opposing connecting rods coupled to the same bearing, with each of connecting rods engaging with a corresponding journal of the crankshaft over only a portion of the circumference.

### SUMMARY

The present invention may comprise one or more of the features recited in the attached claims, and/or one or more of the following features and combinations thereof. In one aspect, an internal combustion engine may comprise a crankshaft having a first web portion defining an inner opening and defining an undercut proximate the inner opening, a second web portion defining an inner opening and defining an undercut proximate the inner opening and an inner bearing portion that engages with the inner opening of the first web portion and with the inner opening of the second web portion, a first pushrod having a piston end and a crankshaft end, and a second pushrod having a piston end and a crankshaft end, the crankshaft ends of the first and second pushrods each having a concave surface placed over different portions of the inner bearing portion between the first and second web portions, the crankshaft ends of the first and second pushrods each having shoulders adjacent the concave surface thereof that engages with the undercuts of the first and second web portions.

In another aspect, an internal combustion engine may comprise a crankshaft having a first portion defining an opening, a second portion, and a cylindrical member that couples the first portion to the second portion with the cylindrical member engaging with the opening of the first portion, and first and second connecting rods each having a piston end and a crankshaft end with the crankshaft end having a concave surface and two shoulders adjacent the concave surface and with the concave surfaces of the first and second connecting rods placed over the cylindrical member, the concave surfaces of each of the connecting rods each engaging with the cylindrical member over fewer than 175 degrees of the circumference of cylindrical member.

In a further aspect, an internal combustion engine may comprise a crankshaft having a first web portion defining an inner opening, a second web portion defining an inner opening, and an inner bearing portion that engages with the inner opening of the first web portion and with the inner opening of the second web portion, a first pushrod having a piston end and a crankshaft end, a second pushrod having a piston end and a crankshaft end, the crankshaft end of the first pushrod having a concave surface placed over the inner bearing portion between the first and second web portions, the crankshaft end of the second pushrod having a concave surface placed over the inner bearing portion between the first and second web portions, the crankshaft end of the first pushrod having shoulders adjacent the concave surface, the crankshaft end of the second pushrod having shoulders adjacent the concave surface, a first retention ring containing engaging with a first shoulder of the first pushrod and a first shoulder of the second pushrod, and a second retention ring engaging with a second should of the first pushrod and a second shoulder of the second pushrod.

In yet another aspect, an internal combustion engine may comprise a crankshaft having a first web, a second web, and a journal coupled between the first web and the second web, a first connecting rod having a piston end and a crankshaft end, and a second connecting rod having a piston end and a crankshaft end, the crankshaft ends of the first and second connecting rods each having a concave surface placed over the journal, the crankshaft ends of the first and second connecting rods each having two shoulders adjacent the concave surface, and a retention ring formed by separating a portion of the first web proximate the journal from the crankshaft is slid over a first of the shoulders of the first connecting rod and a first of the shoulders of the second connecting rod.

In still another aspect, an internal combustion engine may comprise a cylinder having a first piston and a second piston disposed therein with the pistons arranged in an opposed arrangement, and a built-up crankshaft disposed on one end of the cylinder, the built-up crankshaft having a first outer piece having a first main bearing journal and a first outer journal, a second outer piece having a second main bearing journal and a second outer journal, an inner journal, a first web defining a first outer opening into which the first outer journal is inserted and a first inner opening orifice into which a first end of the inner journal is inserted, and a second web defining a second outer opening into which the second outer journal is inserted and a second inner opening into which a second end of the inner journal, opposite the first end if the inner journal, is inserted, a pushrod coupled between the first piston and the inner journal, a first pullrod coupled between the second piston and the first outer journal, and a second pullrod coupled between the second piston and the second outer journal, wherein at least one of a crankshaft end of the pushrod is continuous and surrounds the inner journal, a crankshaft end of the first pullrod is continuous and surrounds the first outer journal and the second pullrod is continuous and surrounds the second outer journal.

### BRIEF DESCRIPTION OF THE DRAWINGS

FIG. 1 is a built-up crankshaft shown disassembled.

FIG. 2 is an illustration of a portion of the crankshaft of FIG. 1.

FIG. 3 is an illustration of another portion of the crankshaft of FIG. 1.

FIG. 4 is an illustration of a portion of the crankshaft of FIG. 1 further showing two pushrods, four pullrods, and four retaining rings.

FIG. 5 is a cross-sectional view of the crankshaft of FIG. 4.

FIG. 6 is an illustration of a cranktrain according to an embodiment of the disclosure.

FIG. 7 is an illustration of an embodiment of lubrication passages within a crankshaft.

FIG. 8 is an illustration of another embodiment of lubrication passages within a crankshaft.

FIG. 9 is an illustration of a cranktrain according to an embodiment of the disclosure.

FIG. 10 is an illustration of a crankshaft embodiment in which one of the retention rings is harvested from the crankshaft.

FIG. 11 is a cross-sectional detail drawing of a portion of the crankshaft of FIG. 10, as assembled, showing a snap ring to hold a free retention ring in place.

FIG. 12 is another cross-sectional detail drawing of a crankshaft embodiment having dowels for locating portions of the build-up crankshaft rotationally.

FIG. 13 is an illustration of a web of a built-up crankshaft having flats for fixturing to build up the crankshaft.

FIG. 14 is an illustration of an embodiment of a cranktrain of an opposed-piston engine.

FIG. 15 is an exploded view of the crankshaft of FIG. 14 with two pullrods and a pushrod.

FIG. 16 is a detailed view of a portion of the cranktrain of FIG. 14 illustrating connection of the piston to the pullrods.

FIG. 17 is a block diagram of an engine having two opposed pistons, a single cylinder, and a single crankshaft.

FIG. 18 is a block diagram of an embodiment showing processes by which the crankshaft of FIGS. 14-16 can be assembled with the connecting rods

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

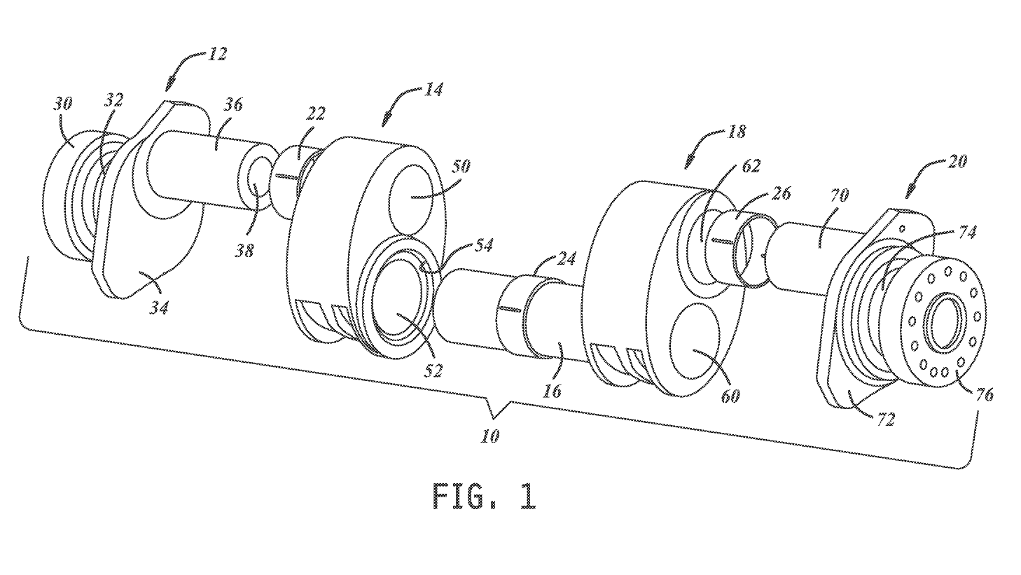

A built-up crankshaft 10, according to an embodiment of the disclosure, is shown in exploded view in FIG. 1. Crankshaft 10 includes a first main bearing portion 12, a first web portion 14, an inner bearing portion 16, a second web portion 18, and a second main bearing portion 20. First main bearing portion 12 has a flange 30, a main bearing journal 32, a counterweight 34, and an outer bearing journal 36. First web portion 14 has an outer opening 50, an inner opening 52, and an undercut 54 proximate inner opening 52. Inner bearing portion 16 is a hollow cylinder. Second web portion 18 is substantially a mirror image of first web portion 14. Second web portion 18 has an outer opening 62, an inner opening 60, and an undercut similar to undercut 54 of first web portion 14 is not visible in the view shown in FIG. 1. Second outer bearing portion 20 is, in the present embodiment, a mirror image of first outer bearing portion 12. Second outer bearing portion 10 has an outer bearing journal 70, a counterweight 72, a main bearing journal 74, and a flange 76. Flanges 30 and 76 may couple to a front-end accessory drive and an output shaft, respectively.

Cylindrical bearings 22 and 26 can be slipped onto outer bearing journals 36 and 70, respectively. To build up the crankshaft, outer bearing journal 36 engages with outer opening 50 via press fit. In alternative embodiments, a key and keyway are provided for alignment purposes and to avoid relative rotation. Any suitable coupling configuration may alternatively be used. Similarly, outer bearing journal 70 is press fit into outer opening 62 of second web portion 18. Also, inner bearing portion 16 is press fit into inner opening 52 of first web portion 14 and press fit into inner opening 60 of second web portion 18. Outer bearing journals 36 and 70 and inner bearing portion 16 are hollow for at least a portion of their length in the illustrated embodiment as represented by 38 in FIG. 1.

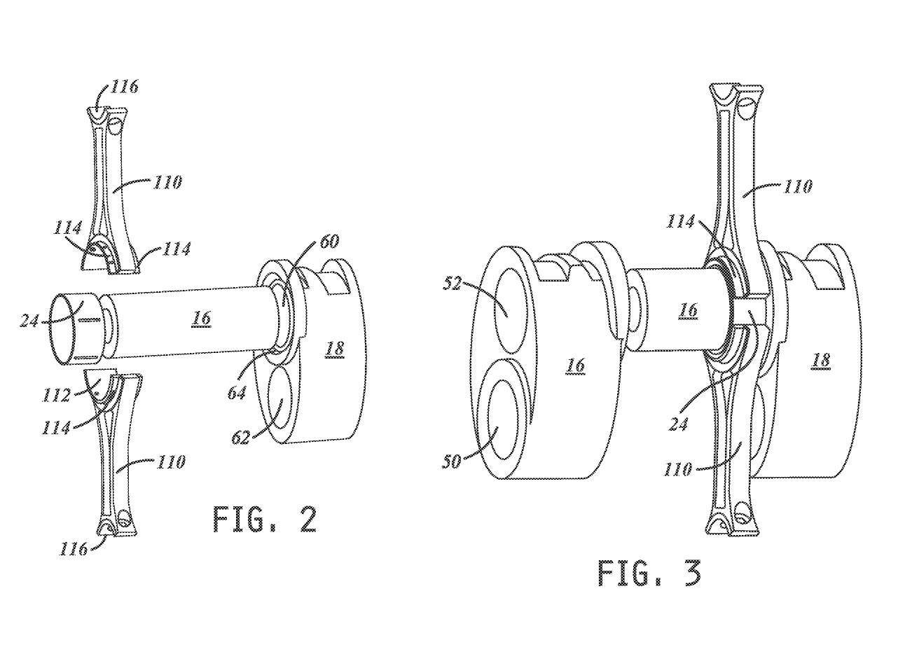

A view of a portion of crankshaft 10 and two pushrods 110 which couple thereto are shown in an exploded view in FIG. 2. Inner bearing 24 slides over inner bearing portion 16 as illustrated in FIG. 1. One end of inner bearing portion 16 is slip fit into inner opening 60 of second web portion 18. On one end of pushrods 110 is a concave surface 112 that is a portion of cylinder. Concave surface 112 sits on the outer surface of inner bearing 24 when assembled. In the embodiment in FIG. 2, bearing 24 is slipped over inner bearing portion 16 and concave surface 112 sits on bearing 24. Alternatively, no bearing is provided and concave surface 112 sits directly on inner bearing portion 16. Pushrod 110 has shoulders 114 proximate concave surface 112. As assembled, one of shoulders 114 engages with an undercut 64 on second web portion 18 as illustrated in FIG. 2. It will be understood that the terms “undercut” and “cutback” used herein each refer to a counterbore formed in one of the crankshaft components, examples of which include the counterbore 54 formed in the first web portion 14 and aligned with the inner opening 52 as illustrated in FIG. 1 and the counterbore 64 formed in the second web portion 18 and aligned with the inner opening 60 as illustrated in FIG. 2. The terms “undercut,” “cutback” and counterbore may be used interchangeably in this disclosure.

In FIG. 3, inner bearing portion 16 is assembled to the second web portion 18. One of shoulders 114 of each of pushrod 110 is slid into undercut 64 of second web portion 18. Concave surfaces 112 of pushrods 110 sit upon the outer surface of inner bearing 24. Pushrods 110 are held in place via shoulders 114 engaging with undercut 64. Concave surfaces 112 are illustratively portions of a cylinder of fewer than 170 degrees circumference. The actual circumferential portion is limited, at least, by the amount that pushrods 110 rock back and forth during rotation of the cranktrain. As illustrated in FIG. 3, the concave surfaces 112 of each of the two pushrods 110 sit upon the same, common bearing, i.e., inner bearing 24. Pullrods rock back and forth less than the pushrods and, thus, can engage with a larger portion of the circumference, but less than 175 degrees circumference.

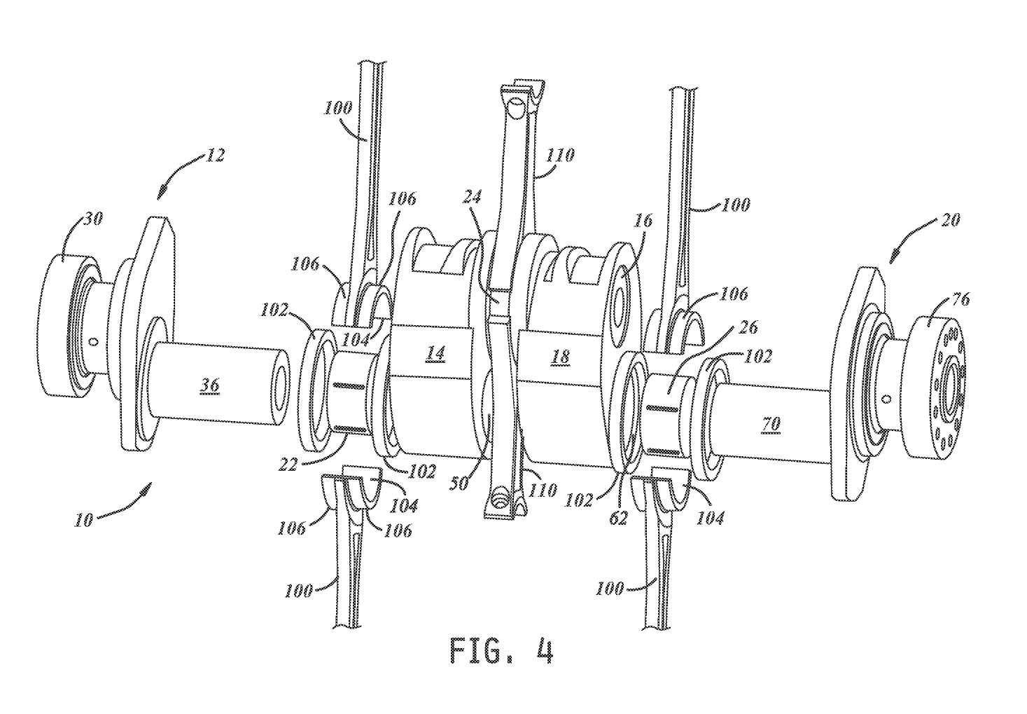

Referring now to FIG. 4, first and second web portions 14 and 18 are engaged with inner bearing portion 16. Shoulders 114 (not visible in FIG. 4) of pushrods 110 are captured in the undercuts 54 and 56 (also not visible in FIG. 4) of first and second web portions 14 and 18, respectively. As crankshaft 10 rotates during operation of the engine, shoulders 114 bear on undercuts 54 and 56.

Continuing to refer to FIG. 4, first main bearing portion 12 is shown disassembled from the rest of crankshaft 10. First main bearing portion 12 has an outer bearing journal 36 that engages with outer opening 50 of first web portion 14. Outer bearing 22 and two pullrod retention rings 102 also slide onto outer bearing journal 36. On one end of pullrods 110 is a concave surface 104 and two shoulders 106 proximate concave surface 104 extend laterally therefrom. Concave surfaces 104 of pullrods 100 bear against outer bearing 22. Retention rings 102 engage with shoulders 106 to hold pullrods 100 on outer bearing 22. Similarly, second main bearing portion 20 has an outer bearing journal 70 that engages with two retention rings 102 an outer bearing 26 and outer opening 62 of second web portion 18. Retention rings 102 engage with shoulders 106 of pullrods 100.

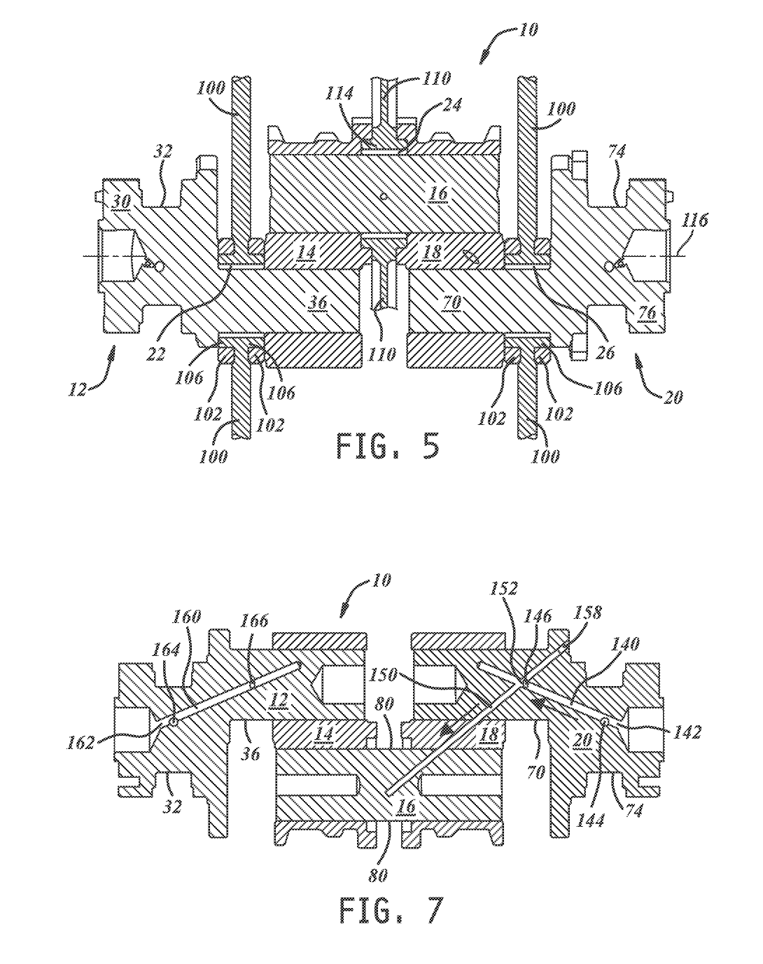

A cross section of the assembled crankshaft with the pullrods and pushrods is shown in FIG. 5. The cross section is not through the diameter but instead forward of the diameter. Recall that the outer bearing journals 36 and 70 and inner bearing portion 16 are hollow. The FIG. 5 cross section is not through the hollow portion. Shoulders 114 of pushrods 110 are captured by cutbacks in first and second web portions 14 and 18.

When crankshaft 10 rotates around axis 116, outer bearing 22 rotates between outer bearing journal 36 and pullrods 100. It is a fully-floating bearing that rotates at a speed less than crankshaft speed. In other embodiments, the bearing is pinned to one of two pullrods 100 or to crankshaft 10. In yet another embodiment, no outer bearing is provided. Instead, the concave surfaces of pullrods 100 bear directly on outer bearing journal 36.

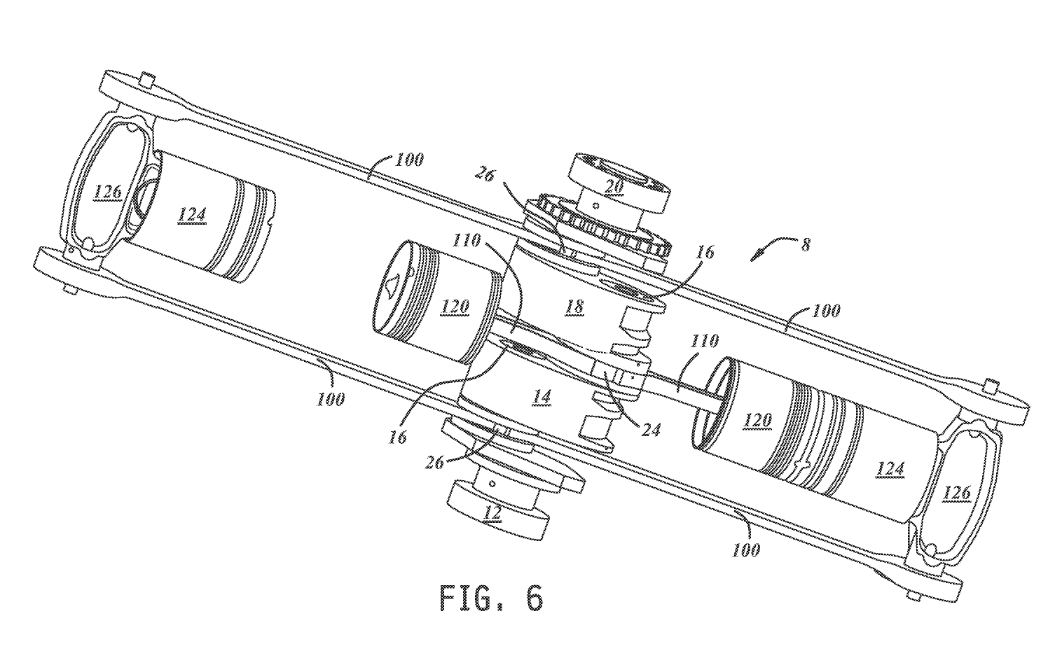

A view of the cranktrain 8 of an opposed-piston, opposed-cylinder engine, including the crankshaft 10 illustrated in FIGS. 1-5, is shown in FIG. 6. A piston 120 couples to each of pushrods 110. Each piston 124 is coupled to a pair of pullrods 100 via a piston bridge 126.

Lubrication passages are illustrated in a cross-sectional view of crankshaft 10 in FIG. 7. A passage 160 has an inlet 162 that is provided pressurized lubricant. A through hole 164 intersects passage 160 to provide lubricant to main bearing journal 32 in two locations on its surface. Lubricant is also provided via a passage 166, which is mostly not visible in FIG. 7. Second main bearing portion 20 has a passage 140 with an inlet 142. The surface of main bearing journal 74 is provided lubricant via a through hole 144 that intersects passage 140. Lubrication is provided to outer journal bearing 70 via a through hole 146 that also intersects passage 140.

A passage 150 passes through second main bearing portion 20, second web portion 18, and inner bearing portion 16. Flow through passage 150 is provided via an intersection 152. Passage 150 is machined from an outer surface of second main bearing portion 20. Passage 150 has a plug 158 near the outer surface of second main bearing portion 20 to ensure that lubricant flows to the bearings instead of leaking out of the opening. A through hole (not shown) in inner bearing portion 16 intersects with passage 150 to provide lubricant to a bearing surface 80 of inner bearing portion 16.

The drilling locations for the lubrication passages in FIG. 7 are chosen to avoid hollow spaces. Of course, in an alternative embodiment, no hollow spaces are provided and there is greater flexibility in where lubricant passages can be machined in the crankshaft.

Referring to FIG. 7, the drilling location on the surface of second main bearing portion 20, i.e., that into which plug 158 is placed, is typical for a unitary crankshaft. However, a built-up crankshaft provides additional opportunities for accessing difficult spots if the machining is done prior to assembly.

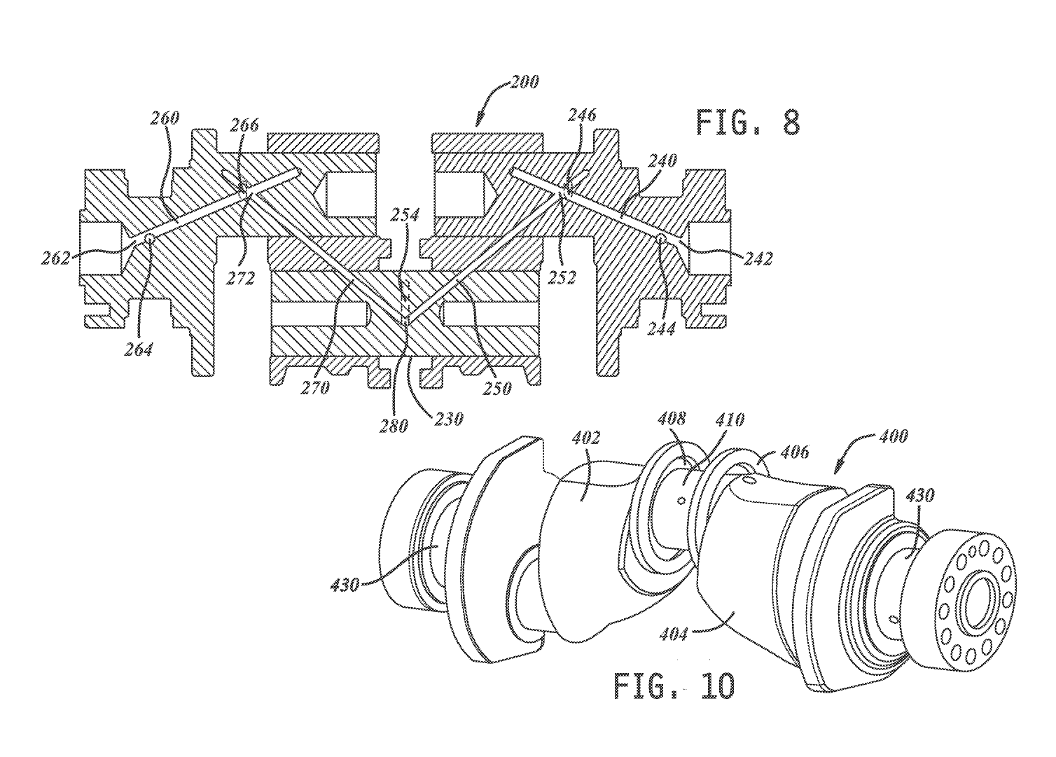

An alternative embodiment of a crankshaft 200 is shown in FIG. 8 in which the flexibility of the built-up crankshaft is utilized to avoid having a plug in an exterior surface. Crankshaft 200 has a passage 260 with an inlet 262 at which pressurized lubricant is provided. Location 262 is also the site at which the machining is initiated to make passage 260. Through holes 264 and 266 intersect passage 260 to provide lubricant to a main bearing and a journal bearing, respectively. A symmetric situation in regards to another main bearing section on the right hand side of crankshaft 200 is shown in which crankshaft 200 has a passage 240 with an inlet 242 and through holes 244 and 246 intersecting passage 240.

Continuing to refer to FIG. 8, additionally passages 270 and 250 are provided, both of which have the drilling initiated on the surface of inner journal bearing 230. Passages 250 and 270 intersect each other and intersect passages 240 and 260 at location 252 and 272, respectively. A through hole 254 provides a passage for lubricant to access the surface of inner bearing 230. One end of passage 254 is shows as 280 in FIG. 8. The embodiment in FIG. 8 is symmetric which should provide better balancing than an asymmetric system. In some embodiments, lubrication from inner bearing 230 is provided to an associated piston (not shown) through an associated pushrod (also not shown). To provide sufficient lubrication to the piston, it may be advantageous to provide two passages, i.e., 250 and 270, thereby increasing the cross sectional area of the lubrication passages.

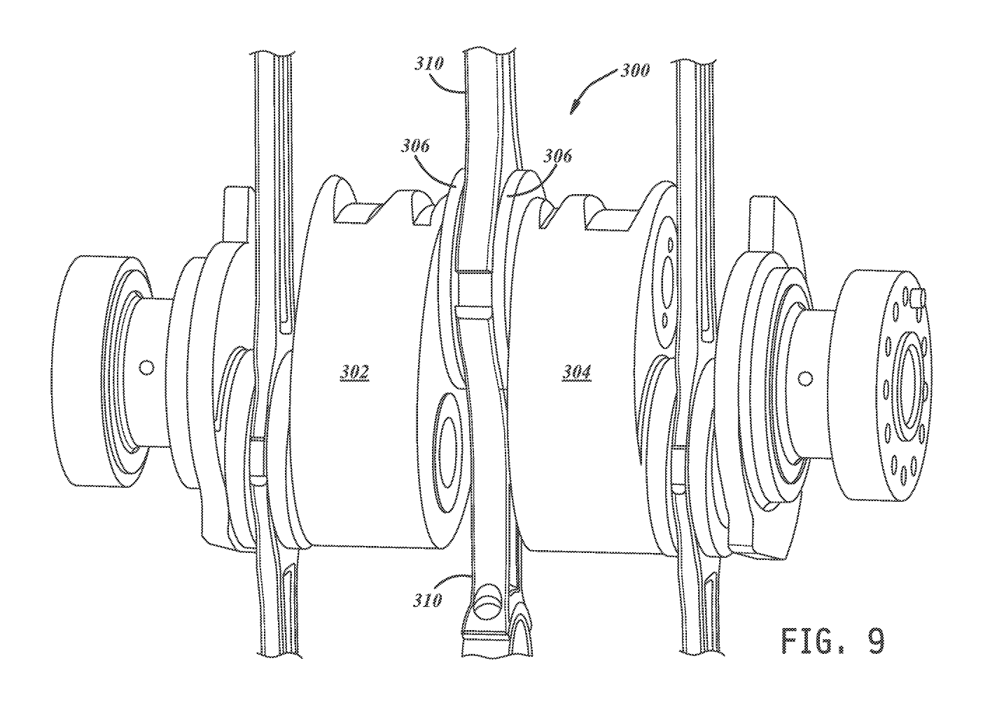

In FIG. 9, an alternative built-up crankshaft 300 is shown in which web portions 302 and 304 do not have undercuts that engage with shoulders of pushrods 310. Instead, retention rings 306 are placed over the shoulders (not visible) to keep a crankshaft end of pushrods 310 engaged with or to the journal of crankshaft 300.

Another alternative crankshaft embodiment is shown in FIG. 10 in which a unitary crankshaft 400 is provided with a first web 402 and a second web 404 that are integrally formed with a journal 410 that extends between webs 402 and 404. First web 402 has an undercut 408 to engage with a shoulder of each of two pushrods. Second web 404 is illustratively formed with additional material in the shape of a retention ring 406. Retention ring 406 is severed from second web 404 by electrical discharge machining or any suitable process.

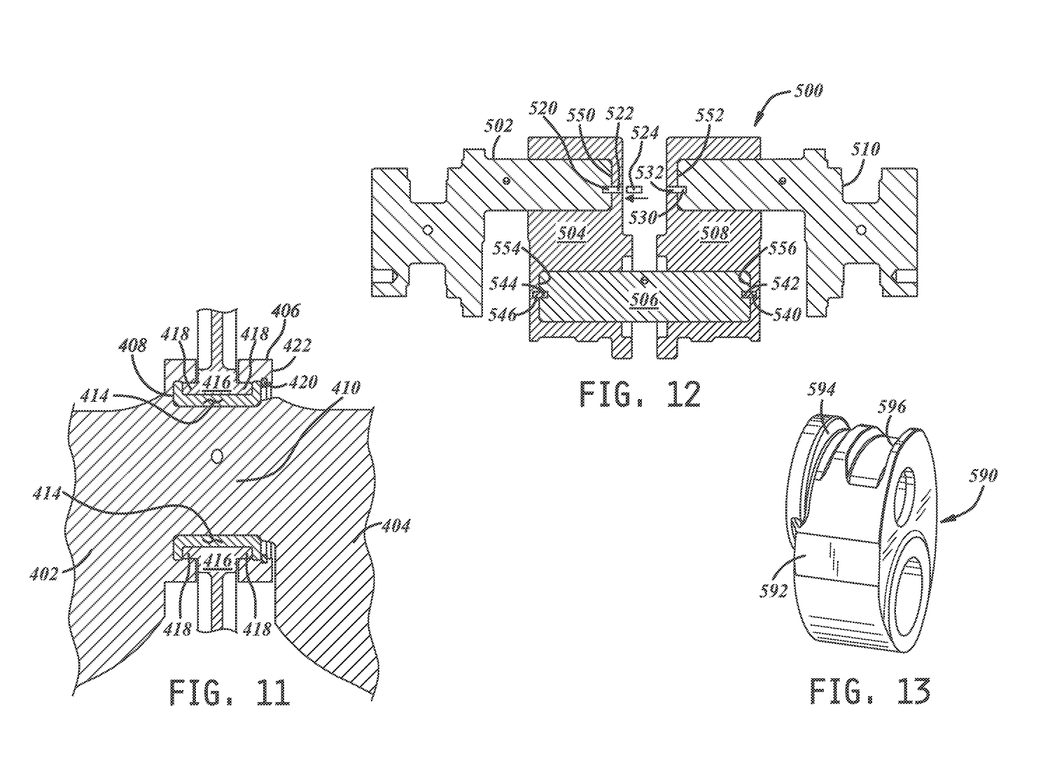

Referring now to FIG. 11, to assemble pushrods 416 onto crankshaft 400 of FIG. 10, one of shoulders 418 of pushrods 416 are engaged with undercut 408. Retention ring 406 is then slid over the other shoulders 418 of the pushrods 406. The spacing between webs 402 and 404 is determined to provide room to move pushrods 416 into journal 410. Ring 406 moves axially to engage the pushrods' shoulders. To maintain ring 406 in the desired location, a snap ring 420 is illustratively snapped into a groove 422 in an underside of retention ring 406. Snap ring 420 holds retention ring 406 in place. The embodiment in FIG. 11 shows a bearing 414 located between journal 410 and pushrods 416. Bearing 414 is illustratively crushed to assume the shape shown. In another alternative embodiment, no bearing is provided and the concave surfaces of pushrods 416 ride directly on journal 410. A coating may be applied to one or both of the mating surfaces to reduce friction.

The embodiment illustrated in FIGS. 10 and 11 show only the inner bearing connection, i.e., to the pushrods. An analogous configuration can be applied to the outer journals 430 for the pullrods with a retention ring harvested from the crankshaft material. Alternatively, a master-slave configuration, such as described in U.S. patent application Ser. No. 14/521,642 (published as Pub. No. US 2015/0114358 A1), which is assigned to the assignee of the subject disclosure, and the disclosure of which is incorporated herein by reference, can be used to couple to a unitary crankshaft. And, in yet another alternative embodiment, the crankshaft can be a built-up crankshaft with only three portions; a first main bearing portion, a second main bearing portion, and an inner portion that includes first and second web portions as well as the journal between the web portions.

Yet another alternative embodiment of a built-up crankshaft 500 compatible with employing a common bearing is shown in FIG. 12. Crankshaft 500 has a first outer main bearing portion 502, a first web portion 504, an inner bearing portion 506, a second web portion 508, and a second outer main bearing portion 510. A hole 520 is provided in main bearing portion 502 that aligns with a through hole 522 in first web portion 504. A dowel pin 524 can be inserted in holes 520 and 522 to secure the first outer main bearing portion 502 to the first web portion 504. Similarly, holes 530 and 532 in second main bearing portion 510 and second web portion 522, respectively, can be aligned and have a dowel pin (not shown) inserted. Holes 546 and 544 in first web portion 504 and inner main bearing portion 506, respectively, are aligned to accept a dowel pin (dowel pin) as well as holes 540 and 542 in second web portion 508 and inner main bearing portion 506, respectively, are also aligned for insertion of a dowel pin (not shown). Holes 540 and 546 are blind holes as opposed to through holes shown for holes 522 and 532.

Assembly of the crankshaft portions 502, 504, 506, 508, and 510 are aided by the openings in the mating part having a positive stop. The embodiment in FIG. 12 shows a positive stop 550 in first web portion 504 that aids in assembling first main bearing portion 502 at the desired relative position. Positive stops 552, 554, and 556 are provided within web portions 504 and 506 to aid with axial alignment of crankshaft 500.

Another aid for assembly is shown in FIG. 13 in which a web 590 is provided flats 592, 594, and 596. Flats 592, 594, and 596 are used in fixtures for assembling a crankshaft according to the desired dimensions.

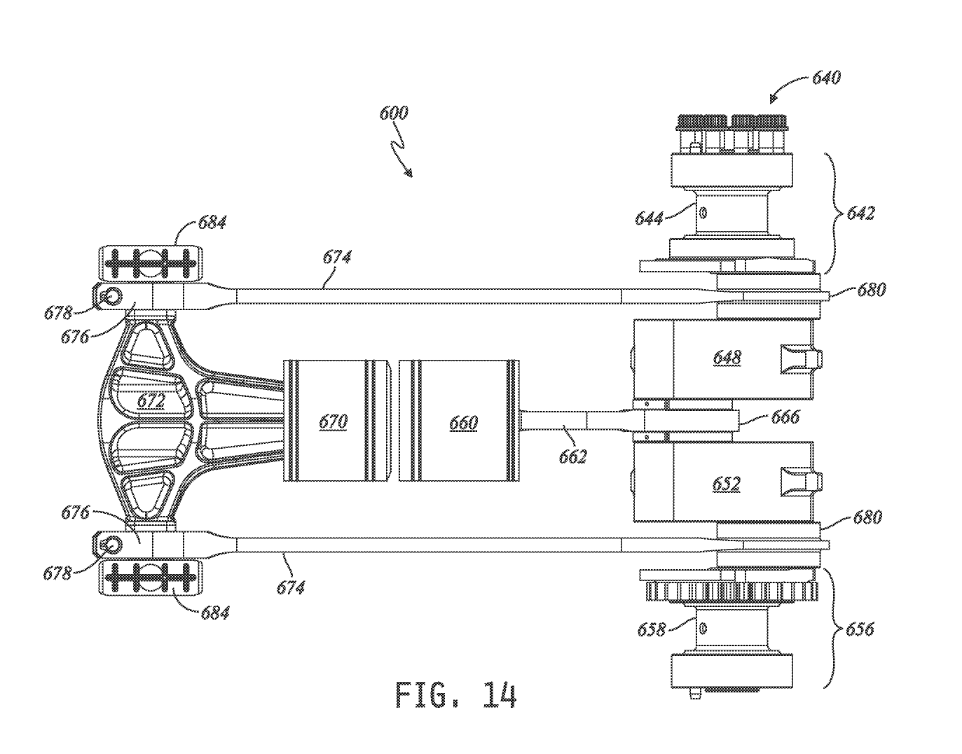

A cranktrain 600 of a shorter alternative to that shown in FIG. 6 is shown in FIG. 14. Referring to FIG. 14, cranktrain 600 has a crankshaft 640 that has a first outer section 642 which includes a first main bearing 644, a first web 648, a second web 652, and a second outer section 656 that includes a second main bearing 658. A first piston 660 is coupled to crankshaft 640 via a pushrod 662 at a crankshaft end 666 of pushrod 662. A second piston 670 couples to crankshaft 640 via a bridge 672 that couples to pullrods 674 on a piston end 676 of pullrods 674. Pullrods 674 couple to crankshaft 640 at the crankshaft end 680 of pullrods 674. Also shown in FIG. 14 are shoes 684 that couple to bridge 672 and ride on linear bearings (not shown in FIG. 14).

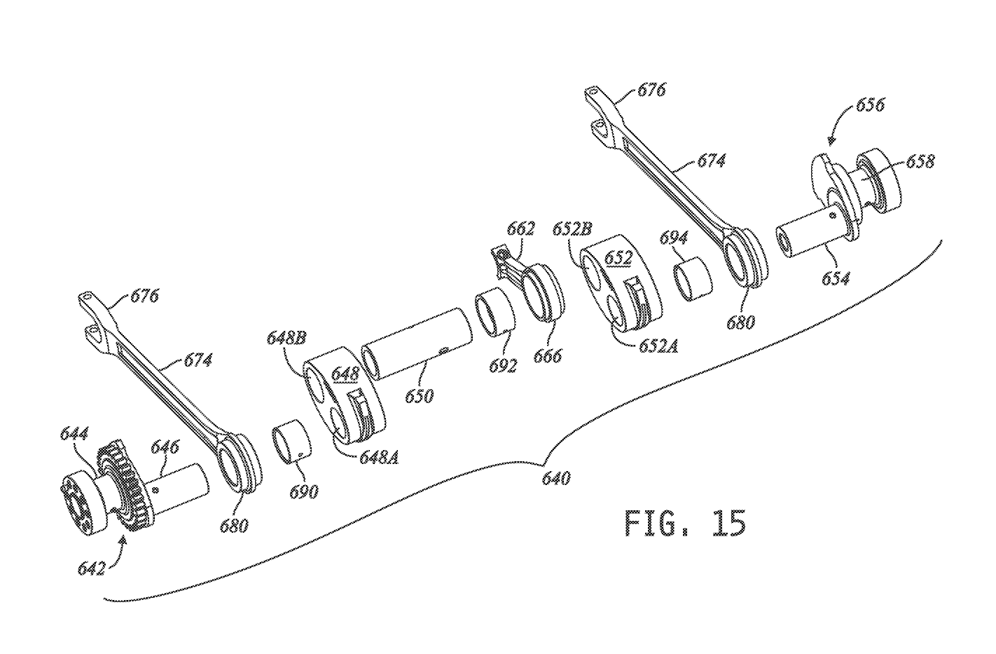

An exploded view of crankshaft 640 is shown in FIG. 15. In one embodiment, first outer journal 646 is integrally formed with first outer section 642. In one alternative embodiment, first outer journal 646 is integrally formed with web 648. In yet another alternative embodiment, first outer journal 646 is a separate component that is assembled to first outer section 642 and web 648. In the embodiment show in FIG. 15, an end of first outer journal 646 is inserted into an opening 648A defined in web 648. Similarly, a second outer journal 654 couples between second web 652 and section outer section 656, with and end of the second journal 654 inserted into an opening 652A defined in web 652. An inner journal 650 couples between webs 648 and 652 by engaging with openings 648B and 652B defined in each of webs 648 and 652 respectively. Bushings 690, 692, and 694 (unitary bearings, e.g., in the form of rings) are placed over journals 646, 650, and 654, respectively, prior to assembling crankshaft 640. Furthermore, crankshaft ends 680 of pullrods 674 and crankshaft end 666 of pushrod 662 are illustratively continuous, i.e., with no break, i.e., contiguous with the rest of the rod. In conventional engines, in contrast, it is common for the crankshaft ends to be split with the smaller portion after the split being a cap that is secured via bolts.

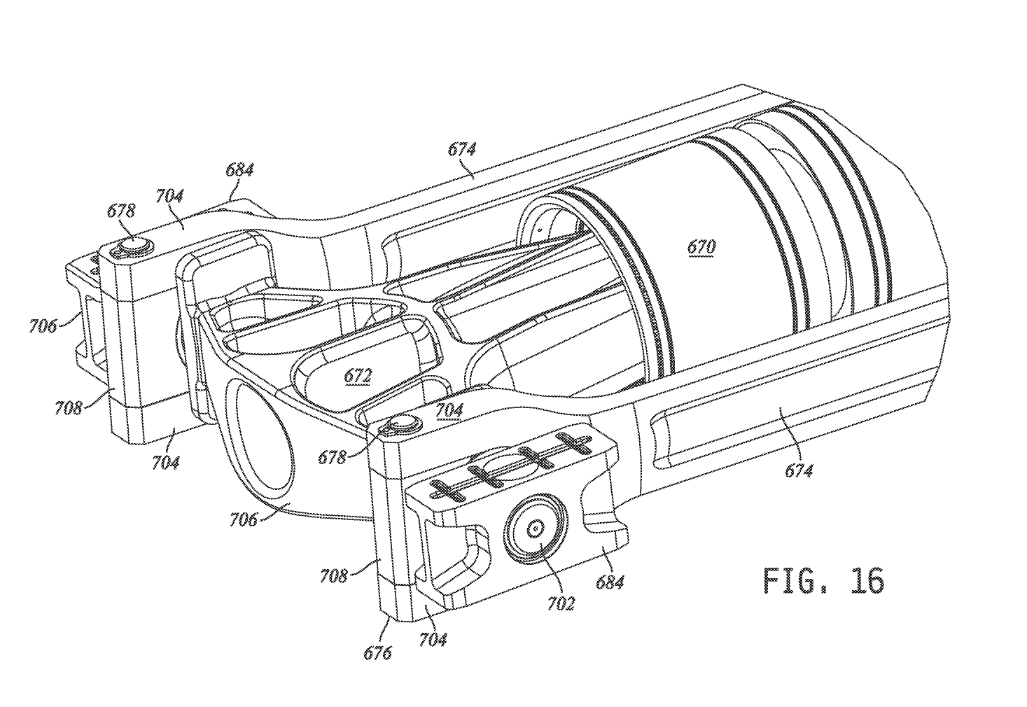

In FIG. 16, a portion of piston 670 and its connection to pullrods 674 via a t-bridge 672 is shown. Bridge 672 has pins 702 that extend out beyond the skirt of piston 670. During assembly, pins 702 of bridge 672 are slid between fingers 704 defined at the piston ends of the pullrods 674. A cap 708 is then slid between fingers 704 and a dowel 678 is slid into an orifice in fingers 704 and in cap 708. In some embodiments, dowel 678 can have a groove around which a clip 706 is installed to keep dowel 678 from sliding out. In one alternative embodiment, the one of the fingers 708 may have a blind hole so that the dowel 678 cannot slide out in one direction and a clip is provided on only one end of the dowel 678. In another alternative embodiment, the middle of the orifice in cap 708 may be threaded and bolts may be inserted in each end which engage with the threaded portions of the cap 708.

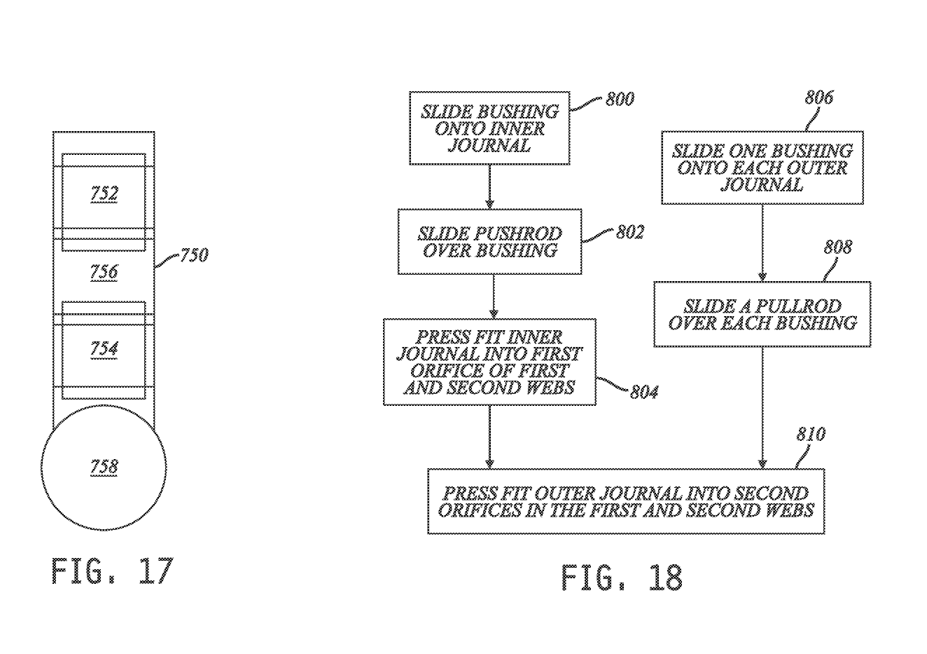

A block diagram of the engine is shown in FIG. 17, in which opposed pistons 752 and 754, each having piston rings, are arranged in a cylinder 750. A combustion chamber 756 is defined by cylinder 750 and the tops of pistons 752 and 754. A crankcase 758 is coupled to one end of cylinder 750

In FIG. 18, an assembly process is shown for assembling the crankshaft 640 according to one embodiment. At block 800 of the illustrated process a bushing is slid onto the inner journal, and then at block 802 a pushrod is slid over the bushing. At block 804, the inner journal is press fit into a first of two openings or orifices in the first and second webs. At block 806, a bushing is slid over each of the two outer journals. In the present embodiment being described, the outer journals are illustratively integral with the outer sections. In an alternative embodiment, the outer journals are separate pieces and are press fit into the outer sections. In any case, a pullrod is slid over each of the two bushings at block 808, and at block 810, the outer journals are press fit into the second openings or orifices in the first and second webs.

### EXAMPLES

In a first example aspect, an internal combustion engine may comprise a crankshaft having a first web portion defining an inner opening and defining an undercut proximate the inner opening, a second web portion defining an inner opening and defining an undercut proximate the inner opening and an inner bearing portion that engages with the inner opening of the first web portion and with the inner opening of the second web portion, a first pushrod having a piston end and a crankshaft end, and a second pushrod having a piston end and a crankshaft end, the crankshaft ends of the first and second pushrods each having a concave surface placed over different portions of the inner bearing portion between the first and second web portions, the crankshaft ends of the first and second pushrods each having shoulders adjacent the concave surface thereof that engages with the undercuts of the first and second web portions.

A second example aspect includes the subject matter of the first example aspect and wherein each of the concave surfaces of the first and second pushrods extends circumferentially on the inner bearing portion over fewer than 170 degrees.

A third example aspect includes the subject matter of the first example aspect and further comprises an inner, cylindrical bearing located radially on the inner bearing portion between the inner bearing portion and concave surface of the crankshaft ends of the first and second pushrods and located axially between the first and second web portions.

A fourth example aspect includes the subject matter of the first example aspect and wherein the first web portion further defines an outer opening and the second web portion further defines an outer opening, and the engine may further comprise a first main bearing portion having a main bearing journal, a flange, a counterweight, and an outer bearing journal, and a second main bearing portion having a main bearing journal, a flange, a counterweight, and an outer bearing journal, the outer bearing journal of the first main bearing portion engaging with the outer opening of the first web portion, and the outer bearing journal of the second main bearing portion engaging with the outer opening of the second web portion.

A fifth example aspect includes the subject matter of the fourth example aspect and may further comprise a first outer bearing placed onto the outer bearing journal of the first main bearing portion, a second outer bearing placed onto the outer bearing journal of the second main bearing portion, and first, second, third, and fourth pullrods each having a piston end and a crankshaft end, the crankshaft end having a concave surface and two shoulders proximate the concave surface, the concave surfaces of the first and second pullrods placed over an outer surface of the first outer bearing each concave surface covering fewer than 175 degrees of the circumference of the first outer bearing, and the concave surfaces of the third and fourth pullrods placed over an outer surface of the second outer bearing each concave surface covering fewer than 175 degrees of the circumference of the second outer bearing.

A sixth example aspect includes the subject matter of the fifth example aspect and may further comprise a first retention ring engaging with a first of the shoulders of the first pullrod and a first of the shoulders of the second pullrod, a second retention ring engaging with a second of the shoulders of the first pullrod and a second of the shoulders of the second pullrod, a third retention ring engaging with a first of the shoulders of the third pullrod and a first of the shoulders of the fourth pullrod, and a fourth retention ring engaging with a second of the shoulders of the third pullrod and a second of the shoulders of the fourth pullrod.

A seventh example aspect includes the subject matter of the fourth example aspect and may further comprise first, second, third, and fourth pullrods each having a piston end and a crankshaft end, the crankshaft end having a concave surface and two shoulders proximate the concave surface, the concave surfaces of the first and second pullrods placed over the outer bearing journal associated with the first main bearing portion, the concave surfaces of the third and fourth pullrods placed over the outer bearing journal associated with the second main bearing portion, and each concave surface of the first, second, third, and fourth pullrods engage with fewer than 175 degrees of the circumference of its associated outer bearing journal.

An eighth example aspect includes the subject matter of the fourth example aspect and wherein a first lubrication passage is defined in the first main bearing portion extending from the flange of the first main bearing portion to the outer bearing journal of the first main bearing portion, a second lubrication passage is defined in the main bearing journal of the first main bearing portion and has an outlet on a surface of the main bearing journal of the first main bearing portion, the second lubrication passage intersecting the first lubrication passage, a third lubrication passage is defined in the outer bearing journal of the first main bearing portion and has an outlet on a surface of the outer bearing journal of the first main bearing portion, the third lubrication passage intersecting the first lubrication passage, a fourth lubrication passage is defined in the second main bearing portion extending from the flange of the second main bearing portion to the outer bearing journal of the second main bearing portion, a fifth lubrication passage is defined in the main bearing journal of the second main bearing portion and has an outlet on a surface of the main bearing journal of the second main bearing portion, the fifth lubrication passage intersecting the third lubrication passage, and a sixth lubrication passage is defined in the outer bearing journal of the second main bearing portion and has an outlet on a surface of the outer bearing journal of the second main bearing portion, the sixth lubrication passage intersecting the fourth lubrication passage.

A ninth example aspect includes the subject matter of the eighth example aspect and wherein a seventh lubrication passage is defined in the crankshaft and extends from a surface of the second main bearing portion through the second web portion and into the inner bearing portion, and an eighth lubrication passage is defined in the inner bearing portion and has an outlet on a surface of the inner bearing portion, the seventh lubrication passage intersecting the fourth and eighth lubrication passages, and wherein the engine further comprises a plug in the seventh lubrication passage proximate the surface of the second main bearing portion.

A tenth example aspect includes the subject matter of the eighth example aspect and wherein a seventh lubrication passage is defined in the crankshaft and extends from a surface of the inner bearing portion through the first web portion and into the first main bearing portion, an eighth lubrication passage is defined in the crankshaft and extends from the surface of the inner bearing portion through the second web portion and into the second main bearing portion, and a ninth lubrication passage extends from one of the seventh and the eighth lubrication passages to the surface of the inner bearing portion, the seventh lubrication passage intersecting with the first, eighth, and ninth lubrication passages and the eighth lubrication passage intersecting with the fourth and ninth lubrication passages.

In an eleventh example aspect, an internal combustion engine may comprise a crankshaft having a first portion defining an opening, a second portion, and a cylindrical member that couples the first portion to the second portion with the cylindrical member engaging with the opening of the first portion, and first and second connecting rods each having a piston end and a crankshaft end with the crankshaft end having a concave surface and two shoulders adjacent the concave surface and with the concave surfaces of the first and second connecting rods placed over the cylindrical member, the concave surfaces of each of the connecting rods each engaging with the cylindrical member over fewer than 175 degrees of the circumference of cylindrical member.

A twelfth example aspect includes the subject matter of the eleventh aspect and may further comprise a first retention ring engaging with a first of the shoulders of the first connecting rod and a first of the shoulders of the second connecting rod, and a second retention ring engaging with a second of the shoulders of the first connecting rod and a second of the shoulders of the second connecting rod.

A thirteenth example aspect includes the subject matter of the eleventh example aspect and wherein the first portion has an undercut proximate the opening, the second portion has an undercut proximate the location where the cylindrical member couples to the second portion, the first shoulder of the first connecting rod and the first shoulder of the second connecting rod engage with the undercut of the first portion, and the second shoulder of the first connecting rod and the second shoulder of the second connecting rod engage with the undercut of the second portion.

A fourteenth example aspect includes the subject matter of the eleventh example aspect and wherein the first portion is a first web portion, the second portion is a first main bearing portion, the connecting rods are pullrods which are primarily in tension during operation of the engine, and the cylindrical member is integrally formed with the first main bearing portion, and wherein the engine further comprises a second web portion defining an opening, a second main bearing portion having a cylindrical member that engages with the opening on the second web portion, a cylindrical inner bearing portion that couples between the first and second web portions, and third and fourth pullrods each having a piston end and a crankshaft end, wherein the crankshaft end has a concave surface and two shoulders adjacent the concave surface, the concave surfaces of the third and fourth pullrods are placed over the cylindrical member of the second main bearing portion, and the concave surfaces of each of the third and fourth pullrods each engage with the cylindrical member over fewer than 175 degrees of the circumference of cylindrical member.

A fifteenth example aspect includes the subject matter of the eleventh example aspect and wherein the first portion is a first web portion, the second portion is a second web portion, the second web portion defining an opening, the cylindrical member further couples with the opening of the second web portion, and the first and second web portions define undercuts proximate their associated openings, and wherein the engine further comprises a first retention ring engaging with a first of the shoulders of the first connecting rod and a first of the shoulders of the second connecting rod, and a second retention ring engaging with a second of the shoulders of the first connecting rod and a second of the shoulders of the second connecting rod.

A sixteenth example aspect includes the subject matter of the eleventh example aspect and wherein the first portion is a first web portion, the second portion is a second web portion, the second web portion defines an opening, and the cylindrical member further couples with the opening of the second web portion, the first shoulder of the first connecting rod and the first shoulder of the second connecting rod engaging with the undercut of the first web portion and the second shoulder of the first connecting rod and the second shoulder of the second connecting rod engaging with the undercut of the second web portion.

A seventeenth example aspect includes the subject matter of the eleventh example aspect and wherein the crankshaft has an axis of rotation, and the first portion has at least one flat surface perpendicular to the axis of rotation for fixturing.

An eighteenth example aspect includes the subject matter of the eleventh example aspect and wherein the opening of the first portion has a positive stop at the end of the opening, and the cylindrical member of the second portion abuts the positive stop of the first portion.

In a nineteenth example aspect, an internal combustion engine may comprise a crankshaft having a first web portion defining an inner opening, a second web portion defining an inner opening, and an inner bearing portion that engages with the inner opening of the first web portion and with the inner opening of the second web portion, a first pushrod having a piston end and a crankshaft end, a second pushrod having a piston end and a crankshaft end, the crankshaft end of the first pushrod having a concave surface placed over the inner bearing portion between the first and second web portions, the crankshaft end of the second pushrod having a concave surface placed over the inner bearing portion between the first and second web portions, the crankshaft end of the first pushrod having shoulders adjacent the concave surface, the crankshaft end of the second pushrod having shoulders adjacent the concave surface, a first retention ring containing engaging with a first shoulder of the first pushrod and a first shoulder of the second pushrod, and a second retention ring engaging with a second should of the first pushrod and a second shoulder of the second pushrod.

A twentieth example aspect includes the subject matter of the nineteenth example aspect and may further comprise a first bearing placed between an outer surface of the inner bearing portion and the concave surfaces of the first and second pushrods.

A twenty first example aspect includes the subject matter of the nineteenth example aspect and wherein the first web portion further defines an outer opening and the second web portion further defines an outer opening, and wherein the engine further comprises a first main bearing portion having an outer bearing journal engaged with the outer opening of the first web portion, a second main bearing portion having an outer bearing journal engaged with the outer opening of the second web portion, a first pullrod having a piston end and a crankshaft end, a second pullrod having a piston end and a crankshaft end, a third pullrod having a piston end and a crankshaft end, and a fourth pullrod having a piston end and a crankshaft end, wherein the crankshaft end of the first pullrod has a concave surface placed over the outer bearing journal of the first main bearing portion, the crankshaft end of the second pullrod has a concave surface placed over the outer bearing journal of the first main bearing portion, the crankshaft end of the third pullrod has a concave surface placed over the outer bearing journal of the second main bearing portion, the crankshaft end of the fourth pullrod has a concave surface placed over the outer bearing journal of the second main bearing portion, and the crankshaft end of the first, second, third, and fourth pullrods also have shoulders adjacent their associated concave surface, and wherein the engine further comprises a third retention ring containing engaging with a first shoulder of the first pullrod and a first shoulder of the second pullrod, a fourth retention ring engaging with a second shoulder of the first pullrod and a second shoulder of the second pullrod, a fifth retention ring containing engaging with a first shoulder of the third pullrod and a first shoulder of the fourth pullrod, and a sixth retention ring engaging with a second shoulder of the third pullrod and a second shoulder of the fourth pullrod.

A twenty second example aspect includes the subject matter of the twenty first example aspect and may further comprise a first bearing placed between an outer surface of the inner bearing portion and the concave surfaces of the first and second pushrods, a second bearing placed between an outer surface of the outer bearing journal of the first main bearing portion and the concave surfaces of the first and second pullrods, and a third bearing placed between an outer surface of the outer bearing journal of the second main bearing portion and the concave surfaces of the third and fourth pullrods.

In a twenty third example aspect, an internal combustion engine may comprise a crankshaft having a first web, a second web, and a journal coupled between the first web and the second web, a first connecting rod having a piston end and a crankshaft end, and a second connecting rod having a piston end and a crankshaft end, the crankshaft ends of the first and second connecting rods each having a concave surface placed over the journal, the crankshaft ends of the first and second connecting rods each having two shoulders adjacent the concave surface, and a retention ring formed by separating a portion of the first web proximate the journal from the crankshaft is slid over a first of the shoulders of the first connecting rod and a first of the shoulders of the second connecting rod.

A twenty fourth example aspect includes the subject matter of the twenty third example aspect and wherein the second web has an undercut proximate the journal, and a second of the shoulders of the first connecting rod and a second of the shoulders of the second connecting rod engage with the undercut of the second web.

A twenty fifth example aspect includes the subject matter of the twenty third example aspect and wherein a second retention ring is formed by separating a portion of the second web proximate the journal, and the second retention ring is slid over a second of the shoulders of the first connecting rod and a second of the shoulders of the second connecting rod.

A twenty sixth example aspect includes the subject matter of the twenty third example aspect and may further comprise a snap ring placed over a majority of the circumference of the journal and located in a groove formed in an underside of the retention ring to thereby locate the retention ring.

A twenty seventh example aspect includes the subject matter of the twenty third example aspect and may further comprise a cylindrical bearing having a first bearing portion and a second bearing portion, each bearing portion comprising 180 degrees of a cylinder, wherein the first bearing portion and the second bearing portion are placed onto the journal between the concave surfaces of the connecting rods and the journal.

In a twenty eighth example aspect, an internal combustion engine may comprise a cylinder having a first piston and a second piston disposed therein with the pistons arranged in an opposed arrangement, and a built-up crankshaft disposed on one end of the cylinder, the built-up crankshaft having a first outer piece having a first main bearing journal and a first outer journal, a second outer piece having a second main bearing journal and a second outer journal, an inner journal, a first web defining a first outer opening into which the first outer journal is inserted and a first inner opening orifice into which a first end of the inner journal is inserted, and a second web defining a second outer opening into which the second outer journal is inserted and a second inner opening into which a second end of the inner journal, opposite the first end if the inner journal, is inserted, a pushrod coupled between the first piston and the inner journal, a first pullrod coupled between the second piston and the first outer journal, and a second pullrod coupled between the second piston and the second outer journal, wherein at least one of a crankshaft end of the pushrod is continuous and surrounds the inner journal, a crankshaft end of the first pullrod is continuous and surrounds the first outer journal and the second pullrod is continuous and surrounds the second outer journal.

A twenty ninth example aspect includes the subject matter of the twenty eighth example aspect and wherein the first and second pullrods each have two substantially parallel fingers extending outwardly from a piston end of the pullrods with the fingers substantially parallel to their associated pullrod.

A thirtieth example aspect includes the subject matter of the twenty ninth example aspect and wherein the first and second pistons each comprise a t-bridge with each t-bridge having first and second pins that extend beyond the associated piston in a diametrically opposed fashion, the first pin sits between the fingers of the first pullrod, the second pin sits between the fingers of the second pullrod, and each of the fingers has an aperture of a predetermined diameter defined therein, and wherein the engine further comprises first and second caps each having an aperture of the predetermined diameter defined therein, and first and second dowels, the first dowel inserted through the apertures of the fingers of the first pullrod and through the aperture of the first cap and the second dowel inserted through the apertures of the fingers of the second pullrod and through the aperture of the second cap.

A thirty first example aspect includes the subject matter of the thirtieth example aspect and wherein the dowels extend out of each end of the fingers and the dowels have a groove near each end, and wherein the engine further comprises first and second clips engaged with the grooves of the first dowel, and third and fourth clips engaged with the grooves of the second dowel.

A thirty second example aspect includes the subject matter of the twenty ninth example aspect and wherein the first and second pistons each comprise a t-bridge with each t-bridge having first and second pins that extend beyond the associated piston in a diametrically opposed fashion, the first pin sits between the fingers of the first pullrod, the second pin sits between the fingers of the second pullrod, and each of the fingers has an apertures defined therein, and wherein the engine further comprises first and second caps each having an aperture defined therein with at least a portion of the aperture being threaded, a first screw inserted through the aperture of a first of the fingers of the first pullrod and engaging with the threads of the aperture in the first cap, a second screw inserted through the aperture of a second of the fingers of the first pullrod and engaging with the threads of the aperture in the first cap, a third screw inserted through the aperture of a first of the fingers of the second pullrod and engaging with the threads of the aperture in the second cap, and a fourth screw inserted through the aperture of a second of the fingers of the second pullrod and engaging with the threads of the aperture in the second cap.

A thirty third example aspect includes the subject matter of the twenty eighth example aspect and may further comprise a first unitary bushing on the first outer journal, and a second unitary bushing on the second outer journal, wherein the first bushing is located between the first pullrod and the first outer journal and the second bushing is located between the second pullrod and the second outer journal.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. An internal combustion engine, comprising:
a crankshaft having a first web portion defining an inner opening and defining an undercut proximate the inner opening, a second web portion defining an inner opening and defining an undercut proximate the inner opening and an inner bearing portion that engages with the inner opening of the first web portion and with the inner opening of the second web portion,
a first pushrod having a piston end and a crankshaft end, and
a second pushrod having a piston end and a crankshaft end, the crankshaft ends of the first and second pushrods each having a concave surface placed over different portions of the inner bearing portion between the first and second web portions, the crankshaft ends of the first and second pushrods each having shoulders adjacent the concave surface thereof that engages with the undercuts of the first and second web portions.

2. The internal combustion engine of claim 1 wherein each of the concave surfaces of the first and second pushrods extends circumferentially on the inner bearing portion over fewer than 170 degrees.

3. The internal combustion engine of claim 1, further comprising an inner, cylindrical bearing located radially on the inner bearing portion between the inner bearing portion and concave surface of the crankshaft ends of the first and second pushrods and located axially between the first and second web portions.

4. The internal combustion engine of claim 1 wherein the first web portion further defines an outer opening and the second web portion further defines an outer opening, the engine further comprising:
a first main bearing portion having a main bearing journal, a flange, a counterweight, and an outer bearing journal, and
a second main bearing portion having a main bearing journal, a flange, a counterweight, and an outer bearing journal, the outer bearing journal of the first main bearing portion engaging with the outer opening of the first web portion, and the outer bearing journal of the second main bearing portion engaging with the outer opening of the second web portion.

5. The engine of claim 4, further comprising:
a first outer bearing placed onto the outer bearing journal of the first main bearing portion,
a second outer bearing placed onto the outer bearing journal of the second main bearing portion, and
first, second, third, and fourth pullrods each having a piston end and a crankshaft end, the crankshaft end having a concave surface and two shoulders proximate the concave surface, the concave surfaces of the first and second pullrods placed over an outer surface of the first outer bearing each concave surface covering fewer than 175 degrees of the circumference of the first outer bearing, and the concave surfaces of the third and fourth pullrods placed over an outer surface of the second outer bearing each concave surface covering fewer than 175 degrees of the circumference of the second outer bearing.

6. The engine of claim 5, further comprising:
a first retention ring engaging with a first of the shoulders of the first pullrod and a first of the shoulders of the second pullrod,
a second retention ring engaging with a second of the shoulders of the first pullrod and a second of the shoulders of the second pullrod,
a third retention ring engaging with a first of the shoulders of the third pullrod and a first of the shoulders of the fourth pullrod, and
a fourth retention ring engaging with a second of the shoulders of the third pullrod and a second of the shoulders of the fourth pullrod.

7. The engine of claim 4, further comprising first, second, third, and fourth pullrods each having a piston end and a crankshaft end, the crankshaft end having a concave surface and two shoulders proximate the concave surface, the concave surfaces of the first and second pullrods placed over the outer bearing journal associated with the first main bearing portion, the concave surfaces of the third and fourth pullrods placed over the outer bearing journal associated with the second main bearing portion, and each concave surface of the first, second, third, and fourth pullrods engage with fewer than 175 degrees of the circumference of its associated outer bearing journal.

8. The engine of claim 4 wherein a first lubrication passage is defined in the first main bearing portion extending from the flange of the first main bearing portion to the outer bearing journal of the first main bearing portion,
a second lubrication passage is defined in the main bearing journal of the first main bearing portion and has an outlet on a surface of the main bearing journal of the first main bearing portion, the second lubrication passage intersecting the first lubrication passage,
a third lubrication passage is defined in the outer bearing journal of the first main bearing portion and has an outlet on a surface of the outer bearing journal of the first main bearing portion, the third lubrication passage intersecting the first lubrication passage,
a fourth lubrication passage is defined in the second main bearing portion extending from the flange of the second main bearing portion to the outer bearing journal of the second main bearing portion,
a fifth lubrication passage is defined in the main bearing journal of the second main bearing portion and has an outlet on a surface of the main bearing journal of the second main bearing portion, the fifth lubrication passage intersecting the third lubrication passage, and
a sixth lubrication passage is defined in the outer bearing journal of the second main bearing portion and has an outlet on a surface of the outer bearing journal of the second main bearing portion, the sixth lubrication passage intersecting the fourth lubrication passage.

9. The engine of claim 8 wherein a seventh lubrication passage is defined in the crankshaft and extends from a surface of the second main bearing portion through the second web portion and into the inner bearing portion, and
an eighth lubrication passage is defined in the inner bearing portion and has an outlet on a surface of the inner bearing portion, the seventh lubrication passage intersecting the fourth and eighth lubrication passages,
and wherein the engine further comprises a plug in the seventh lubrication passage proximate the surface of the second main bearing portion.

10. The engine of 8 wherein a seventh lubrication passage is defined in the crankshaft and extends from a surface of the inner bearing portion through the first web portion and into the first main bearing portion,
an eighth lubrication passage is defined in the crankshaft and extends from the surface of the inner bearing portion through the second web portion and into the second main bearing portion, and
a ninth lubrication passage extends from one of the seventh and the eighth lubrication passages to the surface of the inner bearing portion, the seventh lubrication passage intersecting with the first, eighth, and ninth lubrication passages and the eighth lubrication passage intersecting with the fourth and ninth lubrication passages.

11. An internal combustion engine, comprising:
a crankshaft having a first portion defining an opening, a second portion, and a cylindrical member that couples the first portion to the second portion with the cylindrical member engaging with the opening of the first portion, and
first and second connecting rods each having a piston end and a crankshaft end with the crankshaft end having a concave surface and two shoulders adjacent the concave surface and with the concave surfaces of the first and second connecting rods placed over the cylindrical member, the concave surfaces of each of the connecting rods each engaging with the cylindrical member over fewer than 175 degrees of the circumference of cylindrical member.

12. The engine of claim 11, further comprising:
a first retention ring engaging with a first of the shoulders of the first connecting rod and a first of the shoulders of the second connecting rod, and
a second retention ring engaging with a second of the shoulders of the first connecting rod and a second of the shoulders of the second connecting rod.

13. The engine of claim 11 wherein the first portion has an undercut proximate the opening, the second portion has an undercut proximate the location where the cylindrical member couples to the second portion, the first shoulder of the first connecting rod and the first shoulder of the second connecting rod engage with the undercut of the first portion, and the second shoulder of the first connecting rod and the second shoulder of the second connecting rod engage with the undercut of the second portion.

14. The engine of claim 11 wherein the first portion is a first web portion, the second portion is a first main bearing portion, the connecting rods are pullrods which are primarily in tension during operation of the engine, and the cylindrical member is integrally formed with the first main bearing portion,
and wherein the engine further comprises a second web portion defining an opening, a second main bearing portion having a cylindrical member that engages with the opening on the second web portion, a cylindrical inner bearing portion that couples between the first and second web portions, and third and fourth pullrods each having a piston end and a crankshaft end, wherein the crankshaft end has a concave surface and two shoulders adjacent the concave surface, the concave surfaces of the third and fourth pullrods are placed over the cylindrical member of the second main bearing portion, and the concave surfaces of each of the third and fourth pullrods each engage with the cylindrical member over fewer than 175 degrees of the circumference of cylindrical member.

15. The engine of claim 11 wherein the first portion is a first web portion, the second portion is a second web portion, the second web portion defining an opening, the cylindrical member further couples with the opening of the second web portion, and the first and second web portions define undercuts proximate their associated openings,
and wherein the engine further comprises a first retention ring engaging with a first of the shoulders of the first connecting rod and a first of the shoulders of the second connecting rod, and a second retention ring engaging with a second of the shoulders of the first connecting rod and a second of the shoulders of the second connecting rod.

16. The engine of claim 11 wherein the first portion is a first web portion, the second portion is a second web portion, the second web portion defines an opening, and the cylindrical member further couples with the opening of the second web portion, the first shoulder of the first connecting rod and the first shoulder of the second connecting rod engaging with the undercut of the first web portion and the second shoulder of the first connecting rod and the second shoulder of the second connecting rod engaging with the undercut of the second web portion.

17. The engine of claim 11 wherein the crankshaft has an axis of rotation, and the first portion has at least one flat surface perpendicular to the axis of rotation for fixturing.

18. The engine of claim 11 wherein the opening of the first portion has a positive stop at the end of the opening, and the cylindrical member of the second portion abuts the positive stop of the first portion.
